(19) United States
(12) Patent Application Publication
(10) Pub. No.: US 2016/0092071 A1
(43) Pub. Date: Mar. 31, 2016

(54) GENERATE PREVIEW OF CONTENT

(71) Applicant: HEWLETT-PACKARD DEVELOPMENT COMPANY, L.P., Houston, TX (US)

(72) Inventors: Richard James Lawson, Santa Clara, CA (US); Marguerite Letulle, San Mateo, CA (US)

(21) Appl. No.: 14/787,944

(22) PCT Filed: Apr. 30, 2013
(86) PCT No.: PCT/US2013/038836

§ 371 Date: Oct. 29, 2015

(51) Int. Cl. G06F 3/0481; G06F 9/44; G06F 3/0482

(52) U.S. Cl. CPC G06F 3/04817; G06F 3/0482; G06F 9/4443

(57) ABSTRACT

In an implementation a display component can display a user interface. An input component can detect an input to the user interface. A controller can render an icon to launch an application and to generate a preview of the content related to the application. If a first input is detected by the input component the application is launched. If a second input is detected by the input component additional content related to the application is rendered.

### BACKGROUND

An icon is a pictogram displayed on a screen and used to navigate a system. The icon may be a symbol serving as a representation of a software tool, function or a data file accessible on a system.

### BRIEF DESCRIPTION OF THE DRAWINGS

Some examples of the invention are described with respect to the following figures:

FIG. 1 is a block diagram of a device according to an example implementation;

FIG. 2 is a block diagram of a device according to an example implementation;

FIG. 3a-h are the of a user interface according to an example implementation;

FIG. 4 is a flow diagram of a method of managing displayed content according to an example implementation;

FIG. 5 is a flow diagram of a method of managing displayed content according to an example implementation;

FIG. 6 is a computing system including a computer readable medium according to an example implementation.

### DETAILED DESCRIPTION

It is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. It should also be noted that a plurality of hardware and software based devices, as well as a plurality of different structural components may be used to implement the disclosed methods and systems.

An icon may function as an electronic hyperlink or file shortcut to access the programs or data. Computer icons, in conjunction with computer windows, menus and a pointing device can form the graphical user interface (GUI) of the computer device and enable a user to easily and intuitively navigate the system.

An icon does not preview the content of the application. The size of the icon may not be adjustable. In one example implementation, a user may want to quickly view the preview or may want to quickly preview other content generated by the application without launching the application. A user may be able to use a gesture on an input device to temporarily increase the size of the preview area without launching the application.

In example implementations an icon may include a preview of content generated by the application that the icon represents. For example, the icon for a news application may generate a preview of a news article and the icon for an email application may generate the preview of an email. The icon may also be used to launch the application.

In one implementation, a computing device can include a display component to display a user interface. The computing device can include an input component to detect an input to the user interface. A controller can render an icon to launch an application. The processor can also generate a preview of the content related to the application. When a first input is detected by the input component the application is launched. When a second input is detected by the input component additional content related to the application is rendered. Rendering may be producing, from a data file, a graphic image on an output device such as the display.

In another implementation, a method for managing displayed content can include rendering a user interface including a menu on a display. A preview of first content is generated based on the size of an application icon on the menu. A first input can be detected on the menu to launch the application. A second input on the menu can be detected to increase a viewing size of the preview causing second content to be previewed while continuing to render at least a portion of the menu on the display.

In another implementation, a computer readable media can include code that when executed by a processor causes a computing device to render a user interface including a menu on a display component. A first preview of content can be generated based on the size of an application icon on the menu. The processor can receive information from a sensor detecting a first input on the menu and to launch the application including content. The processor can receive information from a sensor detecting a second input on the menu to increase a viewing size of the preview causing second content to be previewed while continuing to render at least a portion of the menu and revert to the first previewed content.

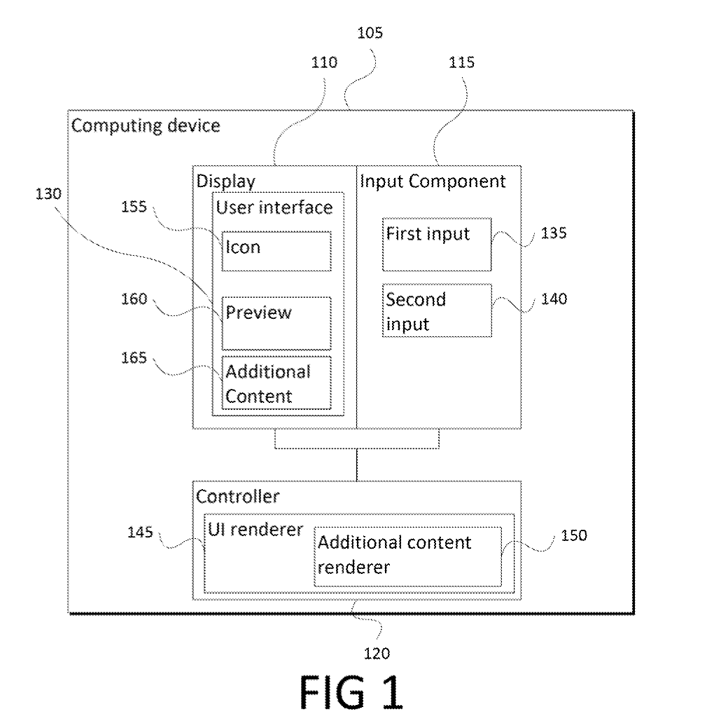

With reference to the figures, FIG. 1 is a block diagram of a device according to an example implementation. A display component 110 to display a user interface 130. The display may be an LCD, OLED or another type of display. The user interface may be a graphical user interface (GUI). A graphical user interface is a visual computer environment that represents applications, files, and options with graphical images, such as icons, menus, and dialog boxes, on the display. A user can select and activate these options by pointing and clicking with a mouse, touchscreen or other input component.

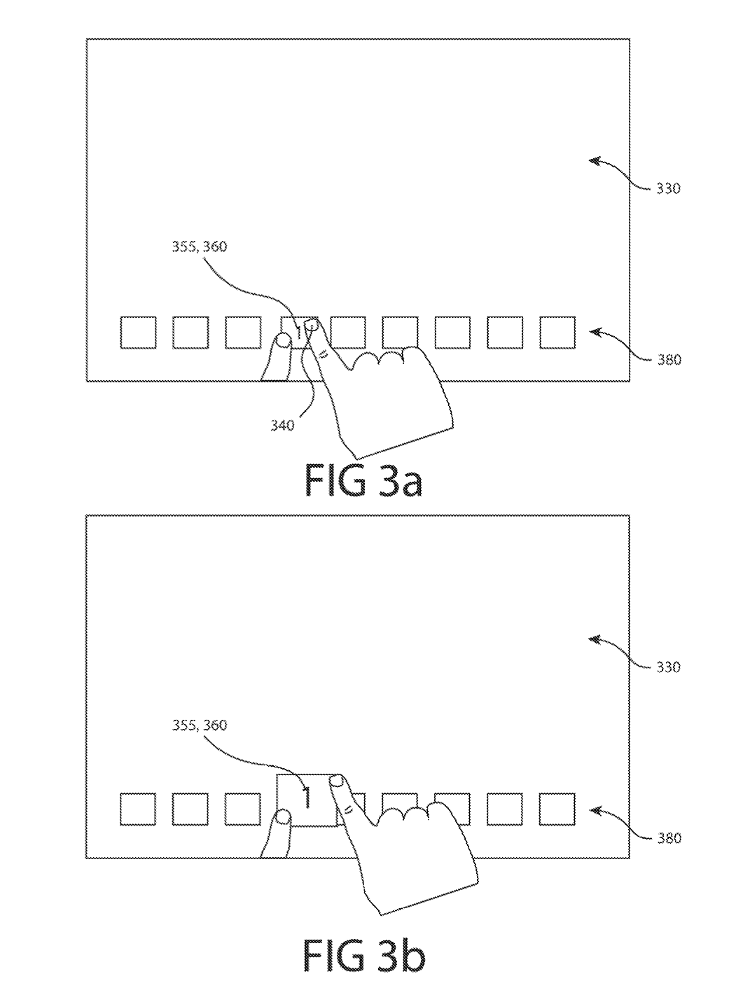

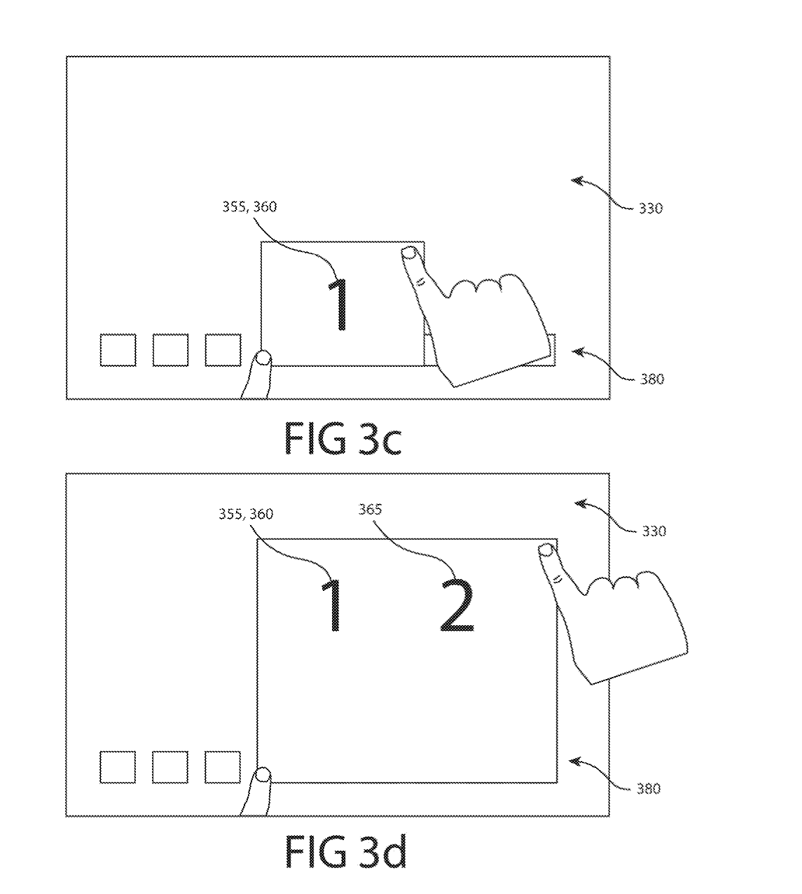

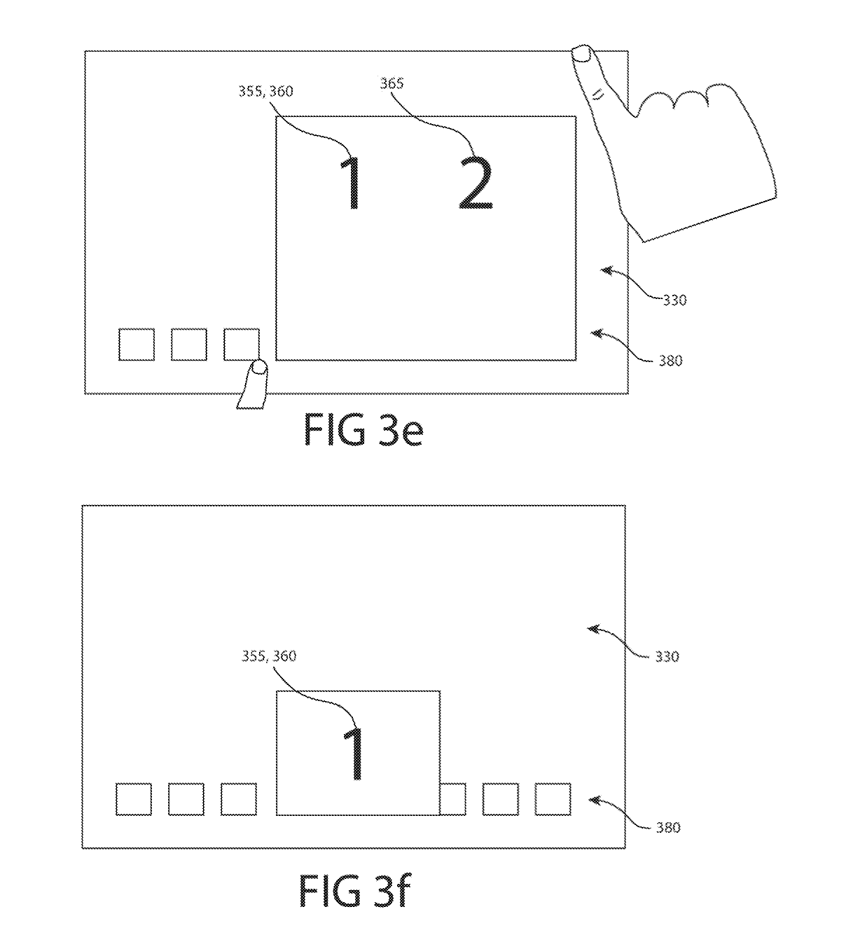

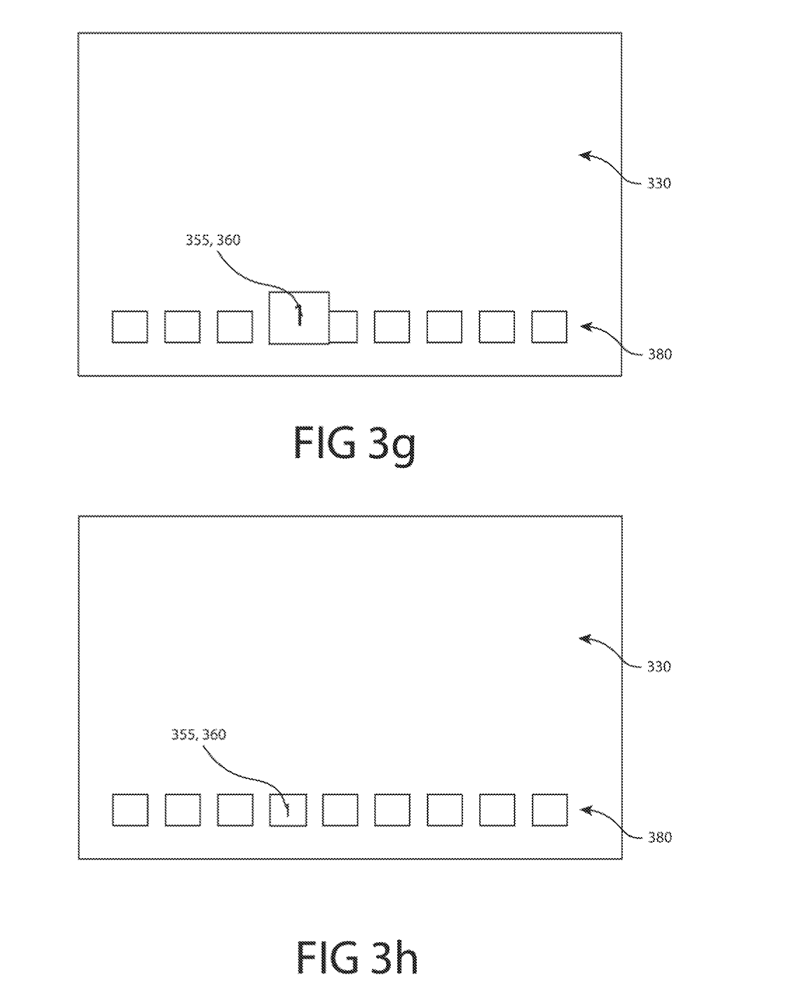

The user interface 130 may include an icon 155 or menu representing an application. An application can cause a computing device to perform useful tasks such as word processing, email, web browsing, social media, news, weather and other tasks. The user interface 130 can include a preview 160 of content. The icon may include the preview 160 as part of the icon or the preview 160 of content may be the icon. The preview 160 can be of the content generated by the application that the icon represents. In some cases the icon may include a preview and static or dynamic symbol that represents the application. The content may be content retrieved or received from the World Wide Web, internet, an intranet or other source. FIG. 3a is an example implementation including an example of a preview 160 and will be described later.

Web content can be the textual, visual, or other content that is encountered as part of the user experience on websites. Web content may include, among other things text, images, sounds, videos and animations. For example the content that is previewed can be emails, social media, news, weather, or other content. Applications can retrieve content from sources to present the content in the user. The content may be in the form of a hypertext markup language (HTML), XML, java, or another content language. If the application is an email application and the content is the emails, the emails may be retrieved for example by POP, IMAP, Exchange or another email protocol. The emails may be for example simple text, HTML or another language. The preview may be a portion of the text or HTML data. If the data is an HTML document the preview may include the HTML formatting or the formatting may be removed from the preview. Removing the formatting may make the data size of the preview smaller and use less of the computing devices' resources such as the processor and memory in rendering the preview. Removing the formatting of the preview data whether the formatting was HTML or some other data formatting may allow multiple previews that look similar between different applications.

The preview content may be determined by date, importance, or another factor, for example the preview may be the most recent email received or the most recent news article, or most recent status update. The determination of the preview content may be determined by user input for example the user may preselect that the previews be selected by the date or may preselect that the previews be selected by importance or by some other factor.

The preview of the content may include an inspection or viewing of the content without launching the application. Launching an application may provide for execution of additional functionality that is not available before launching the application including not being available during the preview.

For example if the application is an email application the content may be an email received and the preview may be for example the sender, the subject, the body of the email or any portion thereof. When the email application is launched the remainder of the content not shown may be visible and the application may provide functions for replying, forwarding, deleting or other actions. If the application is a social media application the preview may be a status update from a friend and if the application is launched additional functionality may be launched examples of social media functionality may be posting pictures or other content. In some cases the preview may include some functionality or content but not all of either the functionality or content that is available when the application is launched.

An input component can detect an input to the computing device. The input component may be a mouse, a touch sensor, or another input component. A touch sensor may be for example a capacitive touch screen, resistive touch screen, an optical touch screen or another type of touch screen. The touch screen may be a multi-touch touch screen meaning that the touch screen can detect multiple inputs at the same time.

A controller 120 can render an icon 155 on the display to launch an application. The controller 120 may be for example an integrated circuit (IC) to executed instructions. The instructions may cause the icon 155 to be rendered. The controller 120 can generate a preview 160 of the content related to the application. The preview 160 of content may be rendered on the user interface. The preview may be in the form of a dynamic icon, tile, widget or another preview.

If a first input is detected by the input component 115 the application is launched. For example a first input 135 may be a touching of a touch screen at the location of the icon and a release under a threshold time such as 1 second.

When a second input 140 is detected by the input component additional content 165 related to the application is rendered. The additional content renderer 150 of the controller 120 renders the additional content 165 to display on the display 110. A second input may be a touching of the preview or the icon and a drag away from the preview or the icon. The additional content 165 is content that is not visible in the preview 160. The additional content may be for example emails that were not previewed if the application is an email application, news articles that were not previewed if the application is a news application, status updates of friends that were not previewed if the application is a social media application. In one implementation the preview is rendered with the additional content and the additional content is enlarged to be visible. FIG. 3c is an example implementation and includes an example of additional content 165.

The input component 115 may be able to process the gesture received and to signal the gesture to a processor of the computing system. For example the input component 115 may be able to determine if the input was a first input 135 or a second input 140. A processor connected to the input component 115 may do the processing on the data from the input component 115 to determine if the input was a first input 135 or a second input 140. When the input component determines the gesture using an application specific integrated circuit (ASIC) a processor of the computing device may be relieved of the task and allowed to perform other tasks.

An icon and/or the preview may be part of another application such as an operating system. If the icon is part of another program then the other program, such as the operating system, may include an application programming interface (API) that allows applications to communicate with each other. For example an operating system may include an API that communicates with the application represented by the icon to receive the content for the preview and the additional content.

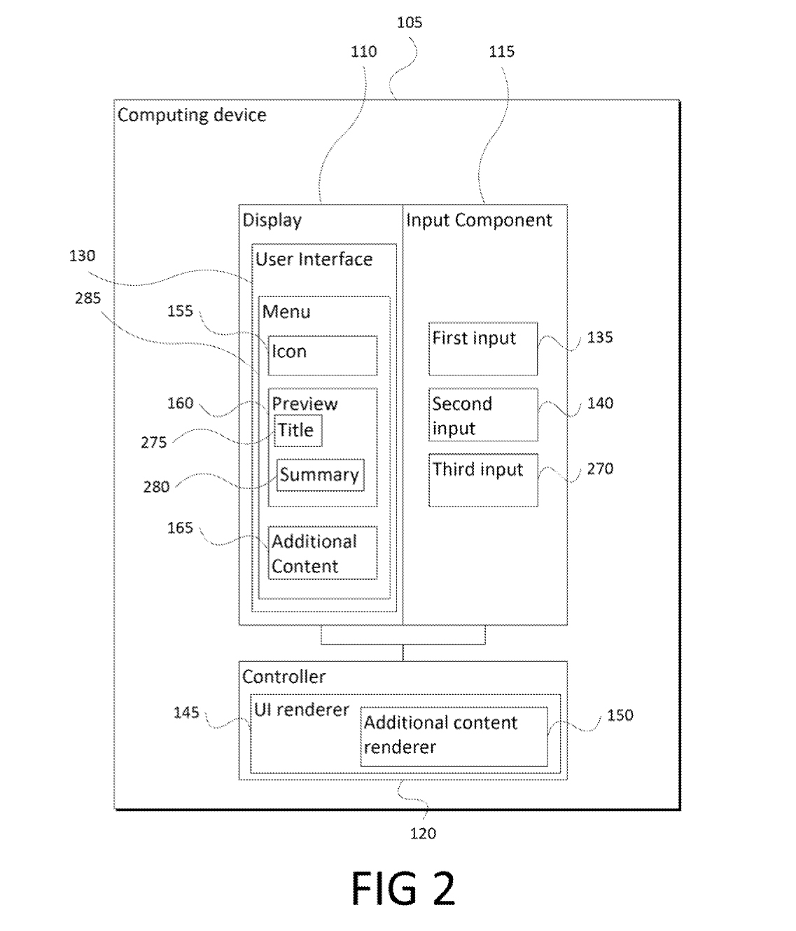

FIG. 2 is a block diagram of a device according to an example implementation. The size of the preview area can be temporarily enlarged from an initial size. The initial size can be the size that shows the preview and not the additional content. When the second input is received the preview area can be temporarily enlarged to display the additional content 165. Temporarily can mean that the preview is enlarged for a period of time and then returns to the non-enlarged size. The period of time may end when for example one of a third input is received or a second input is discontinued. An example of the second input being discontinued can be a user removing their fingers from a touch screen after touching and dragging away from a preview. An example of a third input may be for example if a second input is detected and the user has to double tap the screen for example to return the preview to the initial size from the enlarged size.

In one implementation an amount of additional content is proportional to the size of the temporarily enlarged preview. The size of the enlarged preview may be limited by an edge of the display 110. The size of the enlarged preview may be a size between the size of the initial preview and the enlarged preview limit. The height and the width of the preview may be determined by the ending location of the second input such as when an input is received and dragged away from the preview one of the corners of the preview may be at a location relative to the location of the second input. An example of the amount of additional content being dependent on the size is content A is rendered as the preview, when the second input is received and the preview is enlarged as the input is dragged away content B is displayed when content A and content B can be displayed in the preview. As the preview is enlarged more content C can be displayed in the preview.

The preview 160 can include a title 275, a summary 280 or other content. The summary 280 can include a portion of the content. For example the summary may include an abstract from a news article.

The enlarged preview includes content that was not part of the preview. For example the preview may include content A such as a first email and the enlarged preview may include content B such as a second email in addition to the first email when the preview is of emails.

The user interface 130 can include a menu 285 that includes at least one icon 155. The preview 160 can be part of a menu 285 and the preview 160 is rendered while the menu 285 is rendered. At least a portion of the menu 285 is rendered while the additional content 165 is rendered. As the preview 160 is enlarged portions of the menu may be replaced on the display by the enlarged preview. When the preview 160 returns to the initial size portions of the menu 285 that were not visible when the preview 160 is enlarged are visible.

FIG. 3a-h are the of a user interface according to an example implementation. An example of the user interface 330 displayed on a display. The menu 380 may be an icon 355 or a group of icons. A preview 360 may be the icon 355. The content of the preview 360 is represented by the number 1 in the preview 360. If a first input is received the application represented by the icon can be launched. If a second input 340 is received the preview may be enlarged. For example if the second input 340 drags away from the preview 360 the preview can enlarge. The second input starts in FIG. 3a and as it drags away from the initial preview shown in FIG. 3a the preview area gets larger relative to the initial size as shown in FIG. 3b. In FIG. 3c the preview 360 continues to get larger.

Additional content 365, represented by the number 2, may appear when there is enough area in the preview to render the additional content within the preview. A threshold that causes the additional content to be rendered may depend on the data type, size, formatting or other characteristics of the additional content that is to be rendered. As shown in FIG. 3d additional content 365 is rendered in the preview. The preview may continue to a maximum preview size, for example FIG. 3d may be the maximum size for a preview. The maximum preview size may be the edge of the display or some other threshold limit. In one implementation the preview enlarges in the direction of only one input such as from one finger, in another implementation the preview can be enlarged in the two different directions such as if a user moves their fingers in opposite directions from the preview. The second input could also be the detection of 2 fingers on the preview or a single finger to allow for 1 handed operation.

FIG. 3e shows the user interface when the second input 340 is discontinued. Discontinuing may be for example the user lifting their finger from a touch screen as shown. The preview 360 starts to return to the initial size. The preview 360 continues to return to the initial size in and in FIGS. 3f and 3g the preview continues to get smaller and the additional content is no longer displayed in the preview. In FIG. 3h the preview 360 has returned to its initial size.

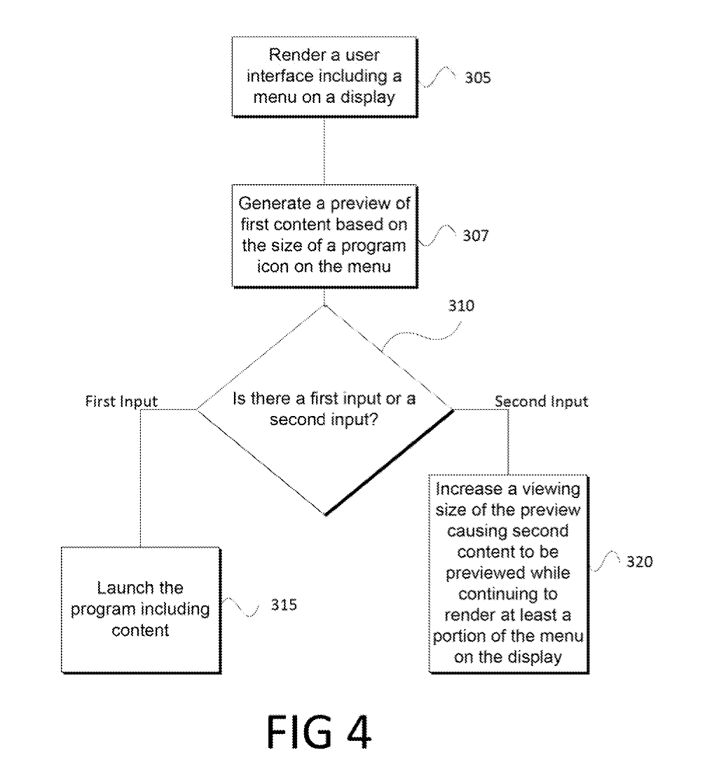

FIG. 4 is a flow diagram of a method of managing displayed content according to an example implementation. The method for managing displayed content can include rendering a user interface including a menu on a display at 305. The user interface may be for example a user interface 130 on display 110. At 307 a first preview of content can be generated based on the size of an application icon on the menu. It can be determined at 310 if a first or a second input is detected. If a first input is detected then the application can be launched. If a second input is detected a viewing size of the icon can be enlarged while continuing to render at least a portion of the menu causing additional content to be previewed.

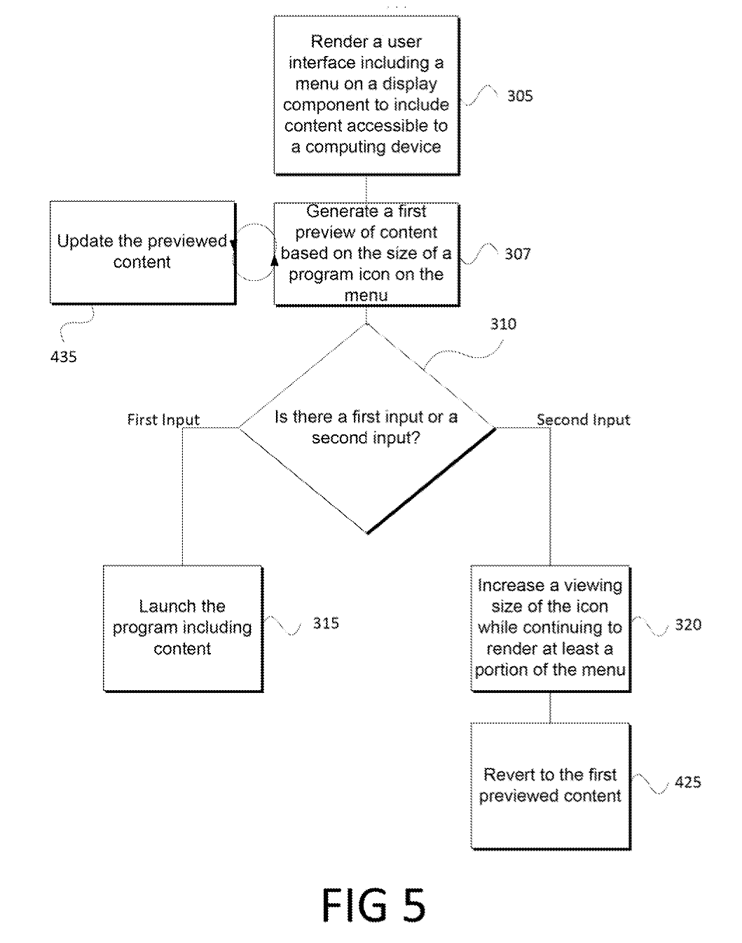

FIG. 5 is a flow diagram of a method of managing displayed content according to an example implementation. The method may identify metadata associated with the content accessible to a computing device and rendering a preview of the content with the metadata at a location of the preview. Descriptive metadata, is about individual instances of application data. Metadata could be described as “data about data content” or “content about content” thus metacontent. For example the metadata for an email may be the sender or the subject and for a news article the metadata may be the title and the date of the article.

If the method increases the viewing size of the preview at 320 then a 425 the previewed content can revert back to the initial preview and not show the additional content shown in the enlarged size of the preview. Reverting to the initial size and preview may be by discontinuing a second input or by receiving a third input.

The previewed content can be constantly updated at 435. The previewed content may be displayed according to date, relevance or some other criteria. For example if the preview is of an email and a newer email is received the preview may be from the most recent email, the preview may also be for example of email received from an email address that a user has put on a favorites list or contact list or other criteria.

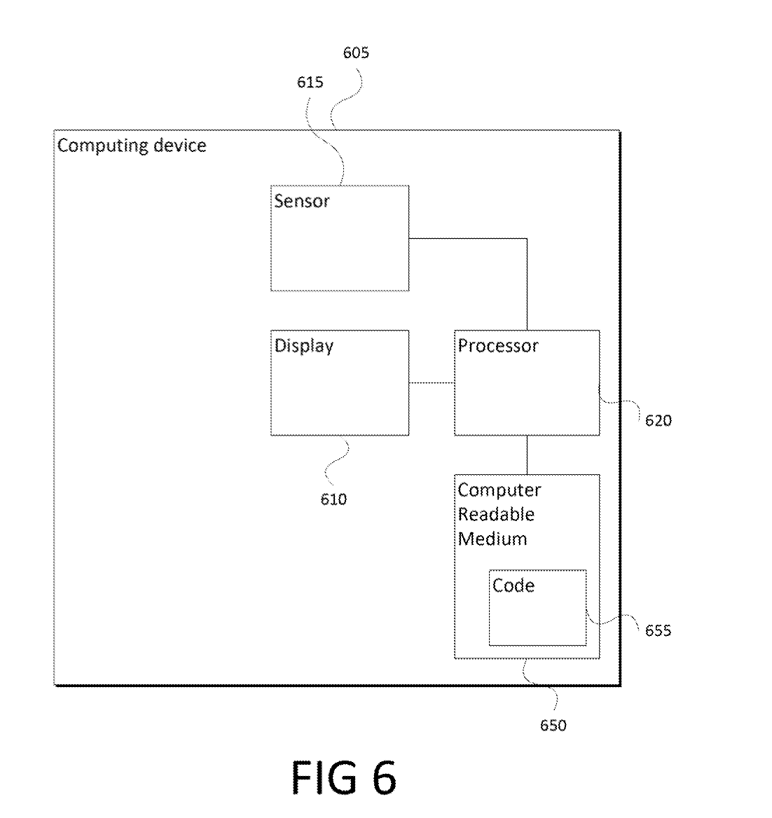

FIG. 6 is a computing device including a computer readable medium according to an example implementation. A computer readable media 650 can include code 655 that if executed by a processor 620 causes a computing device 605 to render a user interface including a menu on a display 610. The processor 620 can generate a first preview of content based on the size of an application icon on the menu. The processor 620 can receive information from a sensor 615 detecting a first input on the menu and to launch the application including content. The sensor may be a mouse, a touch screen or another input sensing device. The processor 620 can receive information from a sensor 615 detecting a second input on the menu and to increase a viewing size of the icon while continuing to render at least a portion of the menu causing second content to be previewed.

The processor 620 can revert the content to the first previewed content. For example reverting to the first previewed content can occur when the preview returns to the initial size after the second input is discontinued or a third input is received. In one implementation the processor can update the previewed content.

The techniques described above may be embodied in a computer-readable medium for configuring a computing system to execute the method. The computer readable media may include, for example and without limitation, any number of the following non-transitive mediums: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and various types of computer-readable media may be used to store the software modules discussed herein. Computing systems may be found in many forms including but not limited to mainframes, minicomputers, servers, workstations, personal computers, notepads, personal digital assistants, phones, tablets, various wireless devices and embedded systems, just to name a few.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed:

1. A computing device comprising:
a display component to display a user interface;
an input component to detect an input to the user interface; and
a controller to render an icon to launch an application and to generate a preview of the content related to the application, when a first input is detected by the input component the application is launched, when a second input is detected by the input component additional content related to the application is rendered.

2. The computing device of claim 1, wherein the size of the preview is temporarily enlarged to display additional content.

3. The computing device of claim 1, wherein the size of the preview returns to an initial size when one of a third input is received or a second input is discontinued.

4. The computing device of claim 2, wherein an amount of additional content is proportional to the size of the temporarily enlarged preview.

5. The computing device of claim 1, wherein the preview includes a title of the content.

6. The computing device of claim 5, wherein the preview includes a summary of the content.

7. The computing device of claim 6, wherein the enlarged preview includes content that was not part of the preview.

8. The computing device of claim 1, wherein the icon is part of a menu and the preview is rendered while the menu is rendered.

9. The computing device of claim 8, wherein the additional content is rendered while at least a portion of the menu is rendered.

10. A method for managing displayed content comprising:
rendering a user interface including a menu on a display;
generating a preview of first content based on a size of an application icon on the menu;
detecting a first input on the menu to launch the application; and
detecting a second input on the menu to increase a viewing size of the preview causing second content to be previewed while continuing to render at least a portion of the menu on the display.

11. The method of claim 10, further comprising identifying metadata associated with the content accessible to a computing device and rendering a preview of the content with the metadata at a location of the preview.

12. The method of claim 10, further comprising reverting to the first previewed content.

13. The method of claim 10, further comprising updating the previewed content.

14. A computer readable media comprising code that when executed by a processor causes a computing device to:
render a user interface including a menu on a display component;
generate a first preview of content based on a size of an application icon on the menu;
receive information from a sensor detecting a first input on the menu and to launch the application including content;
receive information from a sensor detecting a second input on the menu and to increase a viewing size of the preview causing second content to be previewed while continuing to render at least a portion of the menu; and
revert to the first previewed content.

5. The method of claim 14, further comprising the processor to update the previewed content.
